(19) United States
(12) Patent Application Publication
(10) Pub. No.: US 2018/0308136 A1
(43) Pub. Date: Oct. 25, 2018

(54) METHOD AND SYSTEM FOR REGULATING CONSUMER-GENERATED PARTICIPATORY EVALUATIONS WITHIN A REPUTATION MANGEMENT FRAMEWORK

(71) Applicant: Ty King, Palatine, IL (US)

(72) Inventor: Ty King, Palatine, IL (US)

(21) Appl. No.: 15/497,117

(22) Filed: Apr. 25, 2017

(51) Int. Cl. G06Q 30/02

(52) U.S. Cl. CPC G06Q 30/0282; G06Q 30/0263; G06Q 30/0277

(57) ABSTRACT

A method, system and computer program product for wrapping consumer reviews selected by a merchant with review schema and publishing wrapped reviews for search engines to improve reputation and search engine presence online of said merchant.

### FIELD OF THE INVENTION

The present invention relates to reputation management systems online and more particularly relates to a method and system for managing the reviews of consumers across various search engines.

### BACKGROUND

### Description of the Related Art

Consumer reviews of retail businesses have grown to play an important role both in search engine rankings and prospective consumer interest in businesses online. Positive online reviews generate business value for the business being reviewed in marketing to new customers, both on private sites that use custom or open source software to manage their communications and on search engines, as well in piquing prospective consumer interest. Positive online reviews reduce marketing costs to a business by driving organic traffic to the business.

Some businesses seek to drive traffic through falsified reviews in order to increase exposure and reduce marketing costs, but search engine providers such as Google® have become increasingly wise to these techniques and penalize businesses who employ them in search engine rankings. Because of this financial disincentive to falsify reviews, there is all the more need for reputation management services which promote a legitimate reviews from consumers.

The internet based networks include online communities where people discuss and present their opinions on various issues, share knowledge, and review businesses. A user in an online community typically creates a profile by registering on the online community website or providing an identification attribute that can be used for authentication like e-mail, then writes reviews of businesses who have offered services and/or products to the user.

The credibility of a user is usually gauged by search engines which incorporate increasingly complex algorithms for detecting review fraud. Reputation of an individual is built over time depending on the individual's behavior in the community. Reputation plays an important role in determining the credibility of business with prospective consumers.

Conventional reputation management systems do not provide a service to manage user reputation across different online communities or promote positive reviews. There is a need for a reputation management system that automatically selects, or allows users to select, reviews to be promoted which are beneficial to a business. There exists a need in the industry for managing online reviews for businesses in a manner which increases the online foot print of legitimate reviews and consequential positive exposure to an underlying business. This need may be met by wrapping review schema around a positive review.

It would be valuable to provide a reputation management review framework which aggregates reviews and allows a business to select one or more for promotion.

### SUMMARY

From the foregoing discussion, it should be apparent that a need exists for a system and method for regulating consumer-generated participatory evaluations within a reputation management framework. Beneficially, such a system and method would provide for a means of automatically wrapping review schema around positive online reviews.

The present invention has been developed in response to the present state of the art, and in particular, in response to the problems and needs in the art that have not yet been fully solved by currently available products. Accordingly, the present invention has been developed to provide a method for regulating consumer-generated participatory evaluations, said method comprising the step of: incorporating a plurality of consumers and merchants into a reputation management framework; prompting one or more consumers to generate a digital consumer review and upload it to a reputation management framework; receiving a plurality of consumer reviews from a plurality of consumers; displaying the plurality of consumer reviews to a merchant who has provided one of goods and services to the consumer; accepting into computer readable memory a selection of consumers, the selection comprises a plurality of unique identifiers exclusively associated with a consumer review, the selection comprising the merchant's identification of those consumer reviews the merchant wishes to promote online; automatically wrapping each consumer review exclusively associated with a unique identifier with review schema to create one or more wrapped reviews; and publishing the wrapped reviews such that they available to crawlers of a search engine.

A system for regulating consumer-generated participatory evaluations is also provided, the modules of said system comprising: an incorporator module configured to incorporate a plurality of consumers and merchants into a reputation management framework; a prompter module configured to prompt one or more consumers to generate a digital consumer review and upload it to a reputation management framework; a receiver module configured to receive a plurality of consumer reviews from a plurality of consumers; a displayer module configured to display the plurality of consumer reviews to a merchant who has provided one of goods and services to the consumer; an acceptor module configured to accept into computer readable memory a selection of consumers, the selection comprises a plurality of unique identifiers exclusively associated with a consumer review, the selection comprising the merchant's identification of those consumer reviews the merchant wishes to promote online; a wrapper module configured to wrap each consumer review exclusively associated with a unique identifier with review schema to create one or more wrapped reviews; and a publisher module configured to publish the wrapped reviews such that they available to crawlers of a search engine.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a data-entity relationship diagram illustrating consumer review data flow between consumers, a reputation management company, and a search engine in accordance with the present invention;

FIG. 2 is a data-entity relationship diagram illustrating consumer review data flow between consumers, a reputation management company, and a search engine in accordance with the present invention;

FIG. 3 illustrates the steps of a method of regulating consumer-generated participatory evaluations in accordance with the present invention;

FIG. 4 is a block diagram illustrating the modules of a system for regulating consumer-generated participatory evaluations in accordance with the present invention; and

FIG. 5 is a block diagram illustrating the modules of a system for regulating consumer-generated participatory evaluations in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

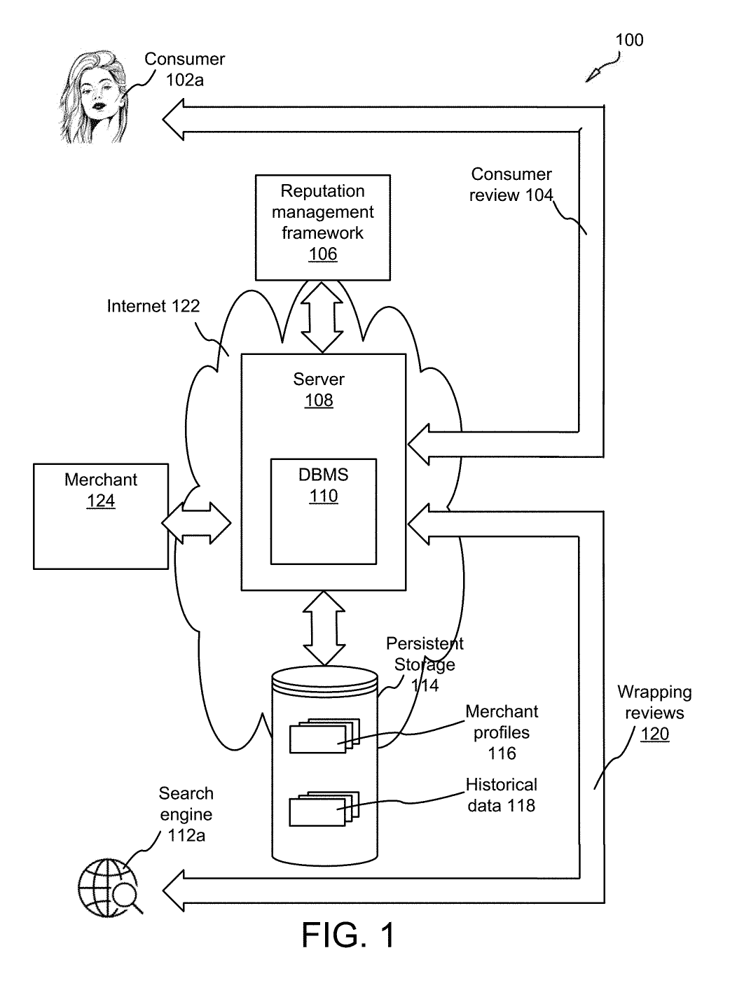

FIG. 1 is a data-entity relationship diagram illustrating consumer review data flow between consumers, a reputation management company, and a search engine in accordance with the present invention.

The consumer 102a may comprise any person, company or organization that purchases good or services from a merchant 124. The consumer and merchant 124 maintain data processing devices which are in logical communication with a server 108 and/or one or more computer programs running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”).

The server be comprised of a single processor or multiple processors of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory is used typically to transfer data and instructions to CPU in a bi-directional manner. Memory 114 may include any suitable computer-readable media, intended for data storage, such as those described above excluding any wired or wireless transmissions unless specifically noted. Mass memory storage may also be coupled bi-directionally to CPU and provides additional data storage capacity and may include any of the computer-readable media described above. Mass memory storage may be used to store programs, data and the like and is typically a secondary storage medium such as a hard disk. It will be appreciated that the information retained within mass memory storage, may, in appropriate cases, be incorporated in standard fashion as part of memory as virtual memory.

The CPU may be coupled to GUI. The GUI enables a user to view the operation of computer operating system and software. The CPU may be coupled to the pointing device. Non-limiting examples of a pointing device include computer mouse, trackball and touchpad. Pointing devices enable a user with the capability to maneuver a computer cursor about the viewing area of GUI and select areas or features in the viewing area of GUI. CPU may be coupled to keyboard. The keyboard enables a user with the capability to input alphanumeric textual information to the CPU. The CPU may be coupled to microphone for recording audio from a consumer. The microphone enables audio produced by a consumer to be recorded, processed and communicated by the CPU. The CPU may also be connected to video camera which enables video produced or captured by consumer to be recorded, processed and communicated by the CPU.

The CPU may also be coupled to input/output interface that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

The server 108 may comprise any database management system (DBMS) 110 or relational database management system (RDBMS) such as Oracle, DB2, IMS, MYSQL, which are highly tuned and carefully managed to ensure that database queries to the DBMS are serviced and returned as quickly as possible. The server 108 may comprise a processor and memory, which are well-known to those of skill in the art.

A reputation management framework 106 is in logical connectivity with the server 108 via a WAN. The reputations management framework 106 may comprise a computer program product or system of interworking modules running on a DPD.

Consumer reviews 104 are generated by a consumer 102a using a DPD in logical connectivity with the server 108. The consumer reviews 104 comprise ratings, a merchant 124 name, and comments generated by the consumer 102a about a merchant 124.

The reputation management framework 106 prompts a consumer 104 to write a review and upload it to the reputation management framework 106. The merchant 124 is prompted to review the reviews through the reputation management framework 106 which have been uploaded for review and to pick those reviews which the merchant 124 wishes to promote. The reputation management framework 106 wraps review schema around the selected reviews and the reviews 120 which are selected and wrapped are crawled by a search engine 112a such as Google® or Bing®.

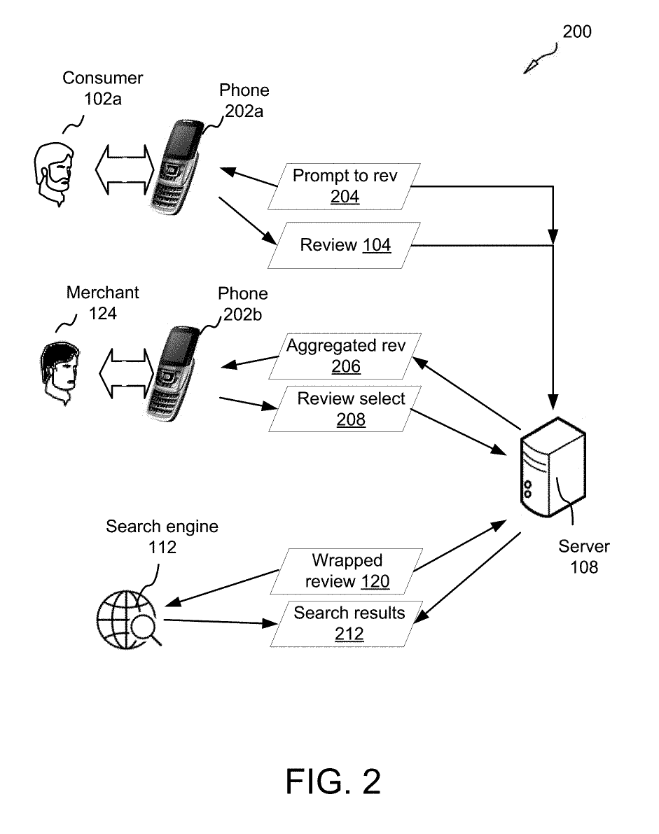

FIG. 2 is a data-entity relationship diagram illustrating consumer review data flow between consumers, a reputation management company, and a search engine in accordance with the present invention.

A consumer 102a who are interconnected using phones 202a with a server 108 comprises computer-readable instructions for executing a reputation management framework 106. The consumers 102a is relayed a message 204 prompting them to generate a review 104 and forward it to the server 108 and reputation management framework 106.

The consumer's 102 smart phone 202 may be coupled to network interface which enables communication with an external device such as a database or a computer or telecommunications or internet network using an external connection shown generally as communication channel, which may be implemented as a hardwired or wireless communications link using suitable conventional technologies. With such a connection, the smart phone might receive information from the network, or might output information to a network in the course of performing the method steps described in the teachings of the present invention.

Aggregated reviews 206 are relayed to, or made available to, the merchant 124 who sends a review selection 208 to the server 108 and reputation management framework 106 comprises one or more reviews 104 which the merchant 124 has selected for promotion by the reputation management framework 110.

The wrapped reviews 120 are received by the search engine 112 which relays 212 search results to prospective consumers via a WAN (wide area network) such as the Internet 122.

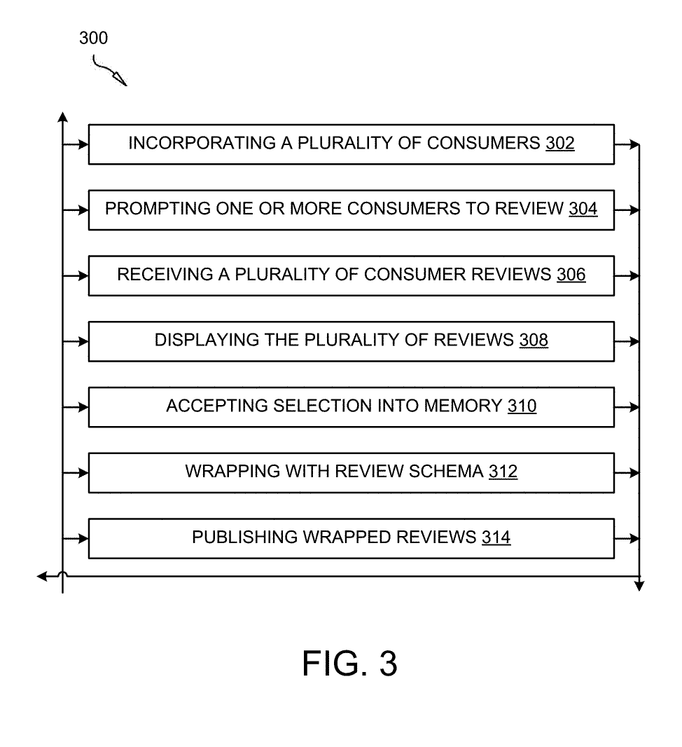

FIG. 3 illustrates the steps of a method of regulating consumer-generated participatory evaluations in accordance with the present invention.

In the illustrated embodiment, the database server on the smart phone routes video content information, or content units, to a merchant via a wide-area network (WAN) such as the Internet. The content units, in various embodiments of the present invention, may comprise video signals, audio signals, textual information, and the like.

In one implementation of the present invention, a method is disclosed, comprising: receiving a bid request from a consumer including a multimedia file associated with a proposed construction job; forwarding the multimedia file to a plurality of merchants who have previously requested to be included in communication; receiving a bid from a merchant (e.g. contractor) determining, in some embodiment, a credibility metric for the merchant/contractor, retrieving a confidence requirement based on the activity request; and determining whether the determined credibility metric satisfies a credibility requirement set by the consumer; and collecting payment from the consumer.

The method comprises the step of executing a mobile application on a processor of a mobile device, said device comprising a camera and wireless connectivity to the internet, wherein said mobile application performs the steps of: utilizing the camera to at least temporarily store photographs onto the mobile device, taken of an area for which the estimate is required; establishing a connection with a web site belonging to a contractor from whom the estimate is required; and transmitting the photographs to the web site.

In a further embodiment method the work to be quoted is selected from the group consisting of moving of items, remodeling, and area painting. In a still further embodiment method the method further includes the steps of: filling out an online request form on the web site; receiving an activation code on the mobile device from the web site; and downloading the mobile application from the web site onto the mobile device.

In one embodiment, the WAN or global network may operate as the Internet. Non-limiting examples of forms a global network include local area networks (LANs), wide area networks (WANs), wired telephone networks, wireless networks, or any other network supporting data communication between respective entities.

In various embodiments, the credibility rating for a merchant is a function of previous ratings assigned to that merchant by consumers. For instance, consumers may be prompted to rate a merchant from one to five, and those ratings collectively averaged to determine a credibility rating for a merchant.

Merchants 124 and consumers 102 are incorporated into the reputation management framework 110, meaning they register with the reputation management framework and create an account exclusively associated with the registrant to which only the registering merchant 124 or consumer 102 has access.

The method 300 begins by incorporating 302 a plurality of consumers and merchants into a reputation management framework. One or more consumers are prompted 504 to generate a digital consumer review and upload it to a reputation management framework.

A reputation management framework 110 receives 306 a plurality of consumer reviews from a plurality of consumers and displays 308 the plurality of consumer reviews to a merchant who has provided one of goods and services to the consumer. The reputation management framework accepts 310 into computer readable memory a selection of consumers, the selection comprises a plurality of unique identifiers exclusively associated with a consumer review, the selection comprising the merchant's identification of those consumer reviews the merchant wishes to promote online.

The reputation management framework automatically wraps 312 each consumer review exclusively associated with a unique identifier with review schema to create one or more wrapped reviews; and publishes 314 the wrapped reviews such that they available to crawlers of a search engine.

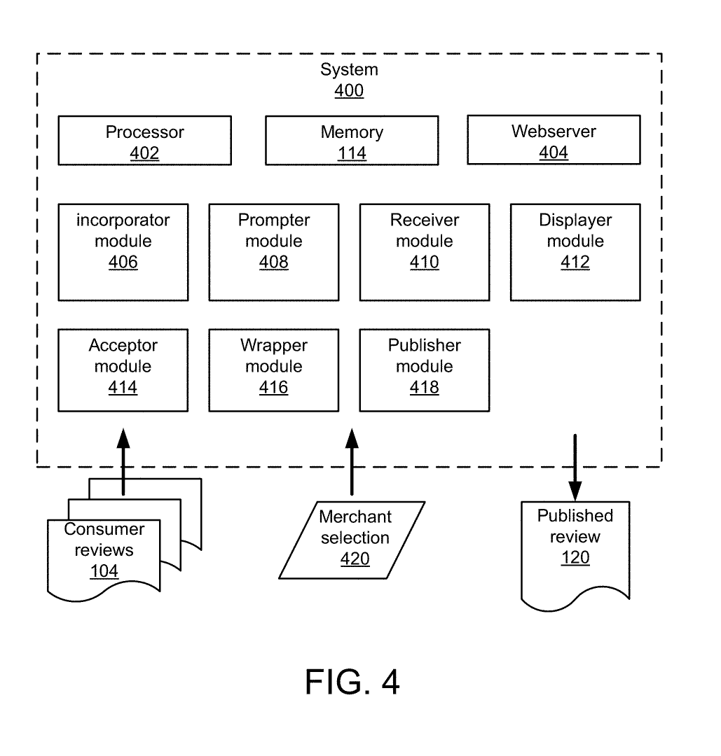

FIG. 4 is a block diagram illustrating the modules of a system for regulating consumer-generated participatory evaluations in accordance with the present invention.

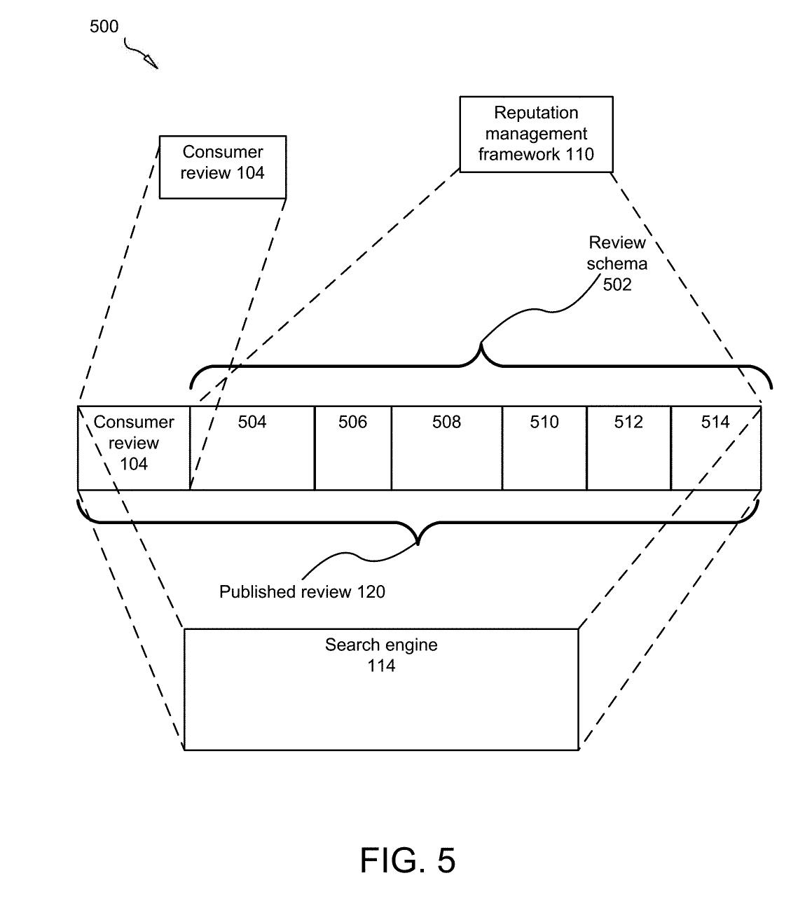

The modules shown in FIG. 5 substantially perform the functions of the steps described in FIG. 4.

FIG. 5 is a block diagram illustrating the modules of a system for regulating consumer-generated participatory evaluations in accordance with the present invention.

A consumer review 104 is wrapped with review schema 502 comprising schema 504-514 by a reputation management framework 110 to create a published review 120 which is submitted to search engines 114.

The published reviews 120 may be dynamically inserted into the websites of merchants 124 and/or clients of the reputation management framework 120.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for regulating consumer-generated participatory evaluations, said method comprising the step of:
incorporating a plurality of consumers and merchants into a reputation management framework;
prompting one or more consumers to generate a digital consumer review and upload it to the reputation management framework;
receiving a plurality of consumer reviews from a plurality of consumers;
displaying the plurality of consumer reviews to a merchant who has provided one of goods and services to the consumer;
accepting into computer readable memory a selection of consumers, the selection comprises a plurality of unique identifiers exclusively associated with a consumer review, the selection comprising the merchant's identification of those consumer reviews the merchant wishes to promote online;
automatically wrapping each consumer review exclusively associated with a unique identifier with review schema to create one or more wrapped reviews; and
publishing the wrapped reviews such that they available to crawlers of a search engine.

2. A system for regulating consumer-generated participatory evaluations, the modules of said system comprising:
an incorporator module configured to incorporate a plurality of consumers and merchants into a reputation management framework;
a prompter module configured to prompt one or more consumers to generate a digital consumer review and upload it to a reputation management framework;
a receiver module configured to receive a plurality of consumer reviews from a plurality of consumers;
a displayer module configured to display the plurality of consumer reviews to a merchant who has provided one of goods and services to the consumer;
an acceptor module configured to accept into computer readable memory a selection of consumers, the selection comprises a plurality of unique identifiers exclusively associated with a consumer review, the selection comprising the merchant's identification of those consumer reviews the merchant wishes to promote online;
a wrapper module configured to wrap each consumer review exclusively associated with a unique identifier with review schema to create one or more wrapped reviews; and
a publisher module configured to publish the wrapped reviews such that they available to crawlers of a search engine.
